(19) United States
(12) Patent Application Publication
(10) Pub. No.: US 2014/0345472 A1
(43) Pub. Date: Nov. 27, 2014

(54) CARTRIDGE RECEPTACLE FOR A BREWING CHAMBER OF A HOT BEVERAGE MACHINE OPERATING ON THE BASIS OF DIMENSIONALLY STABLE BEVERAGE CARTRIDGES

(71) Applicant: BSH BOSCH UND SIEMENS HAUSGEREAETE GMBH, MUENCHEN (DE)

(72) Inventors: Juergen Fritz, Palling (DE); Michael Hoeglauer, Unterwoessen (DE); Michael Steffl, Marquartstein (DE)

(73) Assignee: BSH BOSCH UND SIEMENS HAUSGEREAETE GMBH, MUENCHEN (DE)

(21) Appl. No.: 14/358,188

(22) PCT Filed: Nov. 8, 2012
(86) PCT No.: PCT/EP2012/072091

§ 371 Date: May 14, 2014

(30) Foreign Application Priority Data
Nov. 15, 2011 (DE) 10 2011 086 420.2

(51) Int. Cl. A47J 31/40

(52) U.S. Cl. CPC A47J 31/407
USPC 99/295

(57) ABSTRACT

A cartridge receptacle for a brewing chamber of a hot beverage machine operating on the basis of dimensionally stable beverage cartridges, includes a cartridge carrier, a cartridge holder and a locking device for mounting the beverage cartridge on the cartridge carrier. The cartridge receptacle has at least one damping device that is suitable for compensating for an internal pressure generated in the beverage cartridge by a brewing and/or steam pressure.

The invention relates to a cartridge receptacle for a brewing chamber of a hot beverage machine operating on the basis of dimensionally stable beverage cartridges, having a cartridge carrier, a cartridge holder and a locking device for holding the beverage cartridge onto the cartridge carrier. The invention also relates to a brewing chamber of a hot beverage machine, operating on the basis of dimensionally stable beverage cartridges, which incorporates a cartridge receptacle.

Hot beverage machines, i.e. devices for extracting a substance for the production of a beverage, preferably hot, are known from the prior art. So, for example, DE 20 2008 014 U1 and DE 10 2009 026 830 A1 disclose devices for extracting from sealed beverage cartridges.

The substance, contained in the dimensionally stable sealed cartridges consisting of plastic, metal, or plastic and metal, and generally made of a hard shell with a metal or plastic foil laminated onto it, is either in powder form or liquid. The substance is, for example, roasted and ground coffee, soluble coffee, a mixture of ground coffee and soluble coffee, tea, a chocolate or milk product, or any other consumable dehydrated substance.

In the case of a hot beverage machine of this generic type, for the purpose of extracting a basic beverage material a beverage cartridge is first laid in a cartridge receptacle, then a brewing chamber, which consists of a base plate and a cover and which encloses the cartridge receptacle, is locked closed, and finally the cartridge is exposed to water, which is preferably hot. In this process, water, which may have been heated up, or steam, is fed via the base plate and the cartridge which has been pierced, for example, flowing through or dissolving the basic beverage material which is present in the cartridge. While there is a flow through the basic beverage material, or while it is being dissolved, as applicable, an absolutely desirable brewing pressure of up to 10 bar can build up in the beverage cartridge. Especially during the extraction of ground coffee, a high pressure is advantageous.

At the end of an extraction cycle, the hot beverage machine may then produce a further blast of steam and hence a steam pressure in order to drive out any brewing water which is still in the basic beverage material. This prevents drops subsequently falling from the beverage outlet. The brewing pressure during the brewing, as well as the blast of steam produced at the end of the cycle, result in a high internal pressure in the beverage cartridge. The danger of this is that the glued, welded or crimped beverage cartridge could threaten to burst open at particular weak spots.

In particular if, due to misoperation, the brewing head or the brewing chamber is opened during the extraction cycle or during the final blast of steam, an unrestricted expansion will result, and as a result of this the bursting open of the beverage cartridge, which is still under pressure. In this case, hot water and/or hot basic beverage material can spray out.

The object of the invention is to develop a hot beverage machine of the generic type in such a way that any bursting open, in particular as a result of misoperation, of a beverage cartridge which is under pressure during a brewing operation or during a final blast of steam is avoided by simple and cost-effective means.

This object is achieved by the features of the independent claim 1. Advantageous embodiments and developments, which can be used individually or in combination with each other, are the subject matter of the subclaims.

In accordance with the invention, a cartridge receptacle is provided for a brewing chamber of a hot beverage machine operating on the basis of dimensionally stable beverage cartridges, with a cartridge carrier, a cartridge holder and a locking device for holding the beverage cartridge in the cartridge receptacle, which is characterized by the fact that the cartridge receptacle has a pressure absorbing means which is suitable for balancing out the internal pressure produced in the beverage cartridge by the pressure from brewing and/or from steam.

The cartridge holder can take the form of a half clamp, which can be brought up against the hard shell of a beverage cartridge and locked onto the cartridge carrier. The cartridge holder can also be constructed with a ring shape and can be brought up against an edge, preferably an outer edge, of a cartridge. Holding the cartridge all around it onto the cartridge carrier achieves the highest degree of security, and in addition prevents points on the beverage cartridge from bursting open or tearing open, in particular from the outside inward.

In accordance with the invention, the cartridge receptacle has a locking device for securely holding the cartridge, preferably by means of a close fitting arrangement. The locking device can be, for example, a latching joint with a catch lug on the cartridge holder and an undercut on the cartridge carrier.

To permit convenient opening and closing of the brewing chamber, consisting of a base plate and cover, the cover of the brewing chamber is hinged onto the base plate or, directly or indirectly, onto the hot beverage machine and can be opened in the upward direction.

To permit convenient opening and closing of the cartridge receptacle, the cartridge holder is hinged onto the cartridge carrier, directly or indirectly, preferably by a hinge in the form of a fork, and is opened in the upward direction.

The cartridge receptacle can be hinged, directly or indirectly, onto the base plate or onto the hot beverage machine, preferably by means of a fork. Hinging by means of a fork permits simple withdrawal of the cartridge receptacle, for example in order to clean it after brewing or in order to more simply take a large beverage cartridge out of the brewing chamber. The cartridge receptacle can alternatively, or in addition, also be held removably on the base plate of the brewing chamber by means of the cartridge carrier.

It is preferable that the cartridge receptacle is hinged, directly or indirectly, onto the hot beverage machine so that it is removable and, in addition, is held onto the base plate so that it can be removed, for example via a latching joint.

Additional retention of the cartridge receptacle on the base plate of the brewing head has the advantage that, in the event of an improper opening of the brewing chamber, or the opening of the brewing chamber as a result of misoperation, the pressure prevailing in the interior of the beverage cartridge cannot be dissipated by expansion, i.e. by the cartridge foil blowing out through a gap formed in the cartridge carrier, for example a reading window. Specifically, the cartridge foil, which can be used to seal up a beverage cartridge and which generally lies up against the cartridge carrier, may have printed on it a barcode, which must be readable by a barcode reading device. In addition, it may be that the cartridge is pierced and fed with brewing water through the foil. Hence a reading window must be provided in the cartridge carrier, at least in the region of the barcode.

In accordance with the invention, the cartridge receptacle has a pressure absorbing means which is suitable for balancing out the internal pressure produced in the beverage cartridge by the pressure from brewing and/or steam. The pressure absorbing means is preferably constructed as an elastically recovering device which yields to absorb, to a certain extent, the pressure load prevailing in the cartridge and which after balancing out the pressure returns to its original shape again. Accordingly, pressure balancing for a pressurized beverage cartridge is effected initially by a limited increase in the volume of the cartridge, i.e. a distension of the cartridge, and then by an elastic deformation of the inventive pressure absorbing means. Because the beverage cartridge is held onto the cartridge carrier, and the internal pressure is partially taken up by the inventive pressure absorbing means, distension to the point of bursting open is prevented.

A pressure absorbing means constructed as an elastically recovering arrangement could be, for example, an elastomer located between the cartridge holder, and/or the cartridge carrier, and the beverage cartridge. A pressure absorbing means in accordance with the invention could also be a hinge on the cartridge holder, the elastic section of which is lengthened. Alternatively or additionally, a pressure absorbing means in accordance with the invention can also be obtained by lengthening the elastic section of the catch hook of a latching joint between the base plate and the cartridge carrier.

In what follows, an exemplary embodiment of the present invention is described with reference to the figures, where the features described need not necessarily be of the type shown to realize the objective towards which the invention is directed.

The figures show:

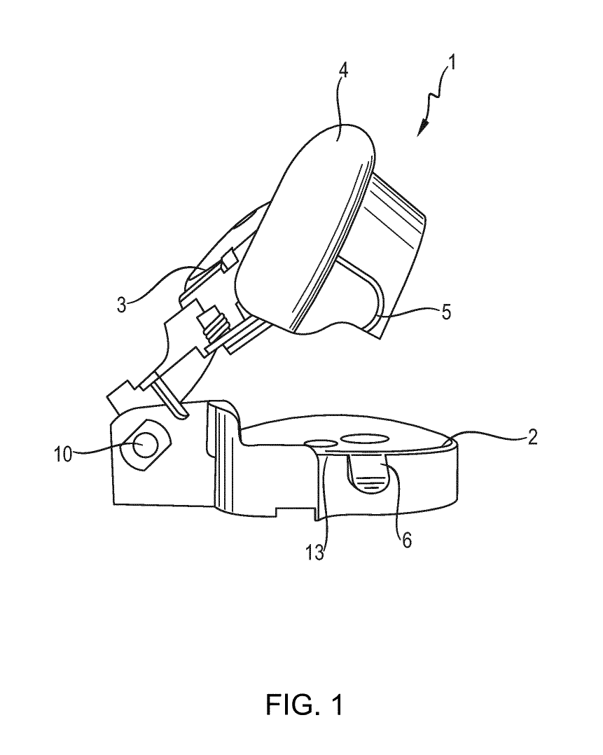

FIG. 1 a side view of an open brewing head, without a cartridge receptacle,

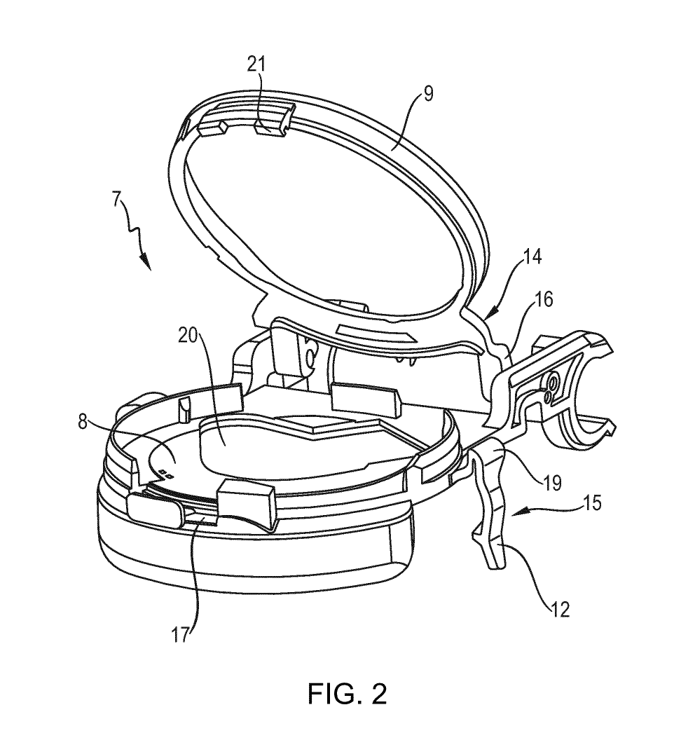

FIG. 2 a perspective view of a cartridge receptacle, and

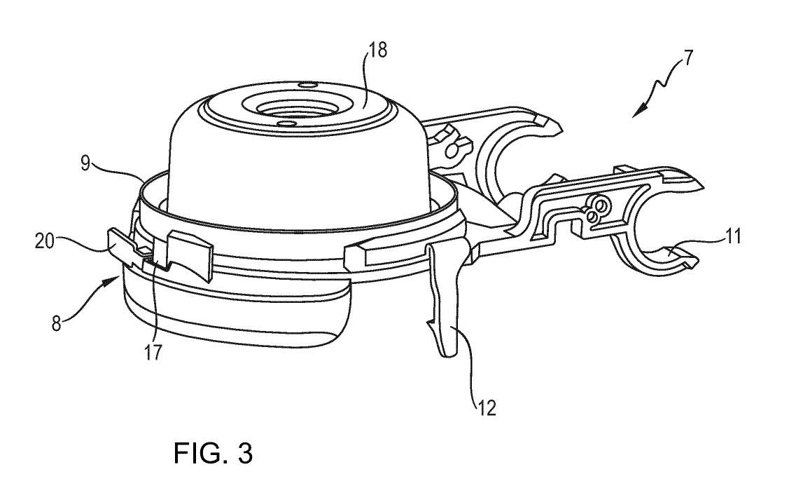

FIG. 3 a side view of a closed cartridge carrier with a beverage cartridge.

As shown in FIG. 1, a brewing chamber 1 of a hot beverage machine operating on the basis of dimensionally stable beverage cartridges includes a base plate 2, a cover 3 hinged onto the base plate 2 and a handle 4 formed on the cover 3. The cover 3 rotates about an axis between a closed position and an open one, so that a brewing chamber 1 formed by the base plate 2 and the cover 3 can conveniently be opened and closed.

In its closed position, the cover 3 is arranged parallel relative to the base plate 2 and forms the sealed brewing chamber 1. On opposite sides of it, the handle 4 has two locking catches 5 which, when the cover 3 and the handle 4 are in the closed position, engage on the two locking pins 6 which are opposite each other on the base plate 2. It follows that in a closed position the cover 3 is locked by a three-point attachment formed by its hinge on the base plate 2 and the two locking catches 5. During the extraction of a basic beverage material, i.e. during the correct usage of a generic hot beverage machine, the brewing chamber 1, which encloses the cartridge receptacle 7 and a beverage cartridge 18, is locked. The receptacle 7 is then hinged on the two opposite pins 10 and positively engaged with the two undercuts 13 on opposite sides.

FIG. 2 shows a cartridge receptacle 7 in isolation. The cartridge receptacle 7 has a cartridge carrier 8, a ring-shaped cartridge holder 9 and a locking device 17. As shown in FIG. 2, the lock is made up of a catch hook and a spring-loaded slider. In order to be able to open and close the cartridge receptacle 7, the cartridge holder 9 is hinged to the cartridge carrier 8 by a hinge 16, and can be opened in an upward direction.

The cartridge receptacle 7 is held onto the base plate 2 by the undercut 13, allowing it to be released, by means of the catch hook 12. This method of holding has the advantage that in the event of an incorrect opening of the brewing chamber, or the opening of the brewing chamber as a result of misoperation, the pressure prevailing in the interior of the beverage cartridge 18 cannot be dissipated by expansion, i.e. by unlimited distension of the cartridge foil through the reading window 20 formed in the cartridge carrier 8.

The cartridge receptacle 7 has pressure absorbing means 14, 15 constructed as elastically recovering facilities which are suitable for balancing out the internal pressure produced by brewing and/or steam pressure in the beverage cartridge 18 (cf. FIG. 3).

The pressure absorbing means 14 is formed by lengthening the elastic section of the hinge 16 of the cartridge holder 9. The lengthening is a result of the hinge 16 having a curved shape. Here, the balancing out of pressure for a pressurized beverage cartridge 18 is initially effected by the limited volume increase of the cartridge 18, i.e. a distension of the cartridge 18, and then by a deformation of the hinge 16 such that it deflects in a vertical direction under the pressure. The locking of the cartridge holder 9 by means of a locking device 17 offers the holder 9 no opportunity for deflection in the region of the lock. Consequently the pivot of the cartridge holder 9 is located in the region of the locking device 17, which amplifies the pressure compensation by the pressure absorbing means 14.

A further pressure absorbing means 15, constructed as an elastically recovering arrangement, is formed by the fact that the catch hooks 12 are curved, and have a U-shaped section 19. The U-shaped section 19 displaces outwards the theoretical elastic pivoting point of the catch 12. Here, a further pressure compensation is initially effected for the beverage cartridge 18 by a volumetric enlargement of the cartridge, i.e. a limited distension of the cartridge foil out through the gap 20, the result of which is initially a lifting of the cartridge carrier 8 from the base plate 2, and then an elastic deformation of the catch hook 12, until finally the carrier 8 is stopped elastically by the latching joint at an angle of some 5°.

FIG. 3 shows a cartridge receptacle 7 holding a beverage cartridge 18. When it is being correctly used, the cartridge receptacle 7 is directly hinged onto two pins 10, which lie opposite each other on the base plate 2 (cf. FIG. 1), by means of the two forks 11. In addition it has an attachment, which can be released, to the base plate 2 by means of two latching joints, formed by two catch hooks 12 which are opposite each other on the carrier 8 and two undercuts 13 (cf. FIG. 1) which are opposite each other on the base plate 2. The hinge joints, formed by the forks 11 and also by the releasable catches, allow the cartridge receptacle 7 to be removed, for example for cleaning purposes. The ring-shaped cartridge holder 9 lies against the outer edge of the cartridge 18 and is locked to the cartridge carrier by means of the locking device 17. The locking device 17 is opened by operating the spring-loaded slider 20, which then releases the catch lug 21 (cf. FIG. 2).

The invention is particularly suitable for beverage cartridges made of a dimensionally stable hard shell which is sealed off with a foil-type cover, for example a cover made of aluminum foil or PE foil, in particular by gluing or welding.

### LIST OF REFERENCE MARKS

1 Brewing head

2 Base plate

3 Cover

4 Handle

5 Locking catches

6 Locking pins

7 Cartridge receptacle

8 Cartridge carrier

9 Cartridge holder

10 Pin

11 Fork

12 Catch hook

13 Undercut

14 Pressure absorbing means

15 Pressure absorbing means

16 Hinge

17 Locking device

18 Beverage cartridge

19 U-shaped section

20 Slider

21 Catch lug

1-8. (canceled)

9. A cartridge receptacle for a brewing chamber of a hot beverage machine configured for operation with dimensionally stable beverage cartridges, the receptacle comprising:
a cartridge carrier, a cartridge holder and a locking device for holding the beverage cartridge onto said cartridge carrier; and
at least one pressure absorbing device disposed and configured for compensating an internal pressure produced in the beverage cartridge by a pressure from brewing and/or from steam.

10. The cartridge receptacle according to claim 9, wherein said cartridge holder is formed with a ring shape, and said ring-shaped cartridge holder is articulated on said cartridge carrier with a hinge.

11. The cartridge receptacle according to claim 10, wherein said hinge is formed with an lengthened elastic section.

12. The cartridge receptacle according to claim 11, wherein said elastic section of said hinge is curved.

13. The cartridge receptacle according to claim 10, wherein said cartridge carrier includes catch hooks.

14. The cartridge receptacle according to claim 13, wherein said hinge is formed with an lengthened elastic section.

15. The cartridge receptacle according to claim 14, wherein said elastic section of said hinge is curved.

16. The cartridge receptacle according to claim 13, wherein said catch hooks are curved and have a U-shaped section.

17. The cartridge receptacle according to claim 9, wherein said receptacle is hinged on two pins on mutually opposite sides of a base plate by two forks.

18. The cartridge receptacle according to claim 17, wherein said receptacle is releasably held on the base plate.

19. The cartridge receptacle according to claim 9, wherein said locking device and said at least one pressure absorbing device are disposed substantially diametrically opposite one another.

20. A brewing chamber of a hot beverage machine operating on a basis of dimensionally stable beverage cartridges, comprising a cartridge receptacle according to claim 9.
